(19) United States
(12) Patent Application Publication
(10) Pub. No.: US 2026/0162312 A1
(43) Pub. Date: Jun. 11, 2026

(54) METHOD AND APPARATUS FOR ENCODING POINT CLOUD DATA AND METHOD FOR TRANSMITTING DATA GENERATED BY POINT CLOUD DATA ENCODING METHOD

(71) Applicant: RESEARCH & BUSINESS FOUNDATION SUNGKYUNKWAN UNIVERSITY, Suwon-si (KR)

(72) Inventors: Eun-Seok RYU, Seoul (KR); Min-Su PARK, Seoul (KR); Jong Beom JEONG, Seoul (KR); Young Gyu KIM, Seoul (KR); Lee Sak YANG, Seoul (KR); Reagan KOO, Seoul (KR)

(73) Assignee: RESEARCH & BUSINESS FOUNDATION SUNGKYUNKWAN UNIVERSITY, Suwon-si (KR)

(21) Appl. No.: 19/408,236

(22) Filed: Dec. 3, 2025

(30) Foreign Application Priority Data
Dec. 6, 2024 (KR) 10-2024-0180117

(51) Int. Cl. G06T 9/00

(52) U.S. Cl. CPC G06T 9/001

(57) ABSTRACT

A method and apparatus for encoding point cloud data and a method for transmitting data generated by the point cloud data encoding method are provided. A method of encoding point cloud data may comprise obtaining the point cloud data, quantizing vertices of meshes within the obtained point cloud data, and generating final meshes based on the quantized vertices.

### CROSS REFERENCE TO RELATED APPLICATION

The present application claims priority to Korean Patent Application No. 10-2024-0180117 filed Dec. 6, 2024, the entire contents of which is incorporated herein for all purposes by this reference.

### BACKGROUND OF THE INVENTION

### Field of the Invention

The present disclosure relates to a method and apparatus for encoding point cloud data, and a method for transmitting a bitstream generated by the point cloud data encoding method, and more specifically, to a technique for more efficiently and quickly processing large-scale point cloud data.

### Description of the Related Art

3D reconstruction is a crucial task in diverse fields such as computer graphics, augmented reality (AR), virtual reality (VR), medical imaging, and autonomous driving. A process of converting point cloud data into accurate and detailed 3D meshes is essential. While various existing algorithms are used for this purpose, problems such as performance degradation and mesh quality degradation in the process of converting the point cloud into the mesh still persist.

To address these problems, a screened-poisson surface reconstruction (S-PSR) algorithm was proposed. The S-PSR algorithm receives point cloud data as input and generates a mesh. During this process, it smooths out noise in the input data and produces a consistent mesh.

### SUMMARY

An object of the present disclosure is to provide a novel mesh generation method that improves upon the existing S-PSR algorithm to enable more efficient and rapid processing of large-scale point cloud data.

In addition, an object of the present disclosure is to provide a method that improves the processing speed of large-scale data, reduces memory usage, and minimizes mesh quality degradation.

In addition, an object of the present disclosure is to provide a method for transmitting data generated by a point cloud data encoding method.

In addition, an object of the present disclosure is to provide a recording medium storing data generated by a point cloud data encoding method.

In addition, an object of the present disclosure is to provide a recording medium storing data received and decoded by a point cloud data encoding apparatus and used for reconstruction of a mesh.

The technical problems solved by the present invention are not limited to the above technical problems and other technical problems which are not described herein can be clearly understood by a person having ordinary skill in the technical field to which the present invention belongs from the description below.

A method of encoding point cloud data according to an aspect of the present disclosure may comprise obtaining the point cloud data, quantizing vertices of meshes within the obtained point cloud data, and generating final meshes based on the quantized vertices.

An apparatus for encoding point cloud data according to an aspect of the present disclosure may comprise a memory and at least one processor. The at least one processor may obtain the point cloud data, quantize vertices of meshes within the obtained point cloud data, and generate final meshes based on the quantized vertices

The features briefly summarized above regarding the present disclosure are merely exemplary aspects of the detailed description of the present disclosure that follows and do not limit the scope of the present disclosure.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating a point cloud-to-mesh conversion and quality control system according to an embodiment of the present disclosure;

FIG. 2 is a flowchart illustrating a point cloud-to-mesh conversion process according to an embodiment of the present disclosure;

FIG. 3 is a flowchart illustrating a 3D mesh generation method according to an embodiment of the present disclosure;

FIGS. 4 to 6 are diagrams illustrating rendering results according to embodiments of the present disclosure; and

FIG. 7 is a diagram illustrating processing time results according to embodiments of the present disclosure.

### DESCRIPTION OF THE PREFERRED EMBODIMENTS

Hereinafter, with reference to the accompanying drawings, embodiments of the present disclosure will be described in detail so that those skilled in the art can easily practice them. However, the present disclosure may be implemented in many different forms and is not limited to the embodiments described herein.

In describing embodiments of the present disclosure, if it is determined that detailed descriptions of known configurations or functions may obscure the subject matter of the present disclosure, detailed descriptions thereof will be omitted. In addition, in the drawings, parts that are not related to the description of the present disclosure are omitted, and similar parts are given similar reference numerals.

In the present disclosure, when it is said that a component is “connected,” “coupled,” or “linked” to another component, this may include not only a direct connection relationship, but also an indirect connection relationship in which another component exists in between. In addition, when it is said that a component “include” or “have” another component, this does not mean excluding the other component, but may further include another component, unless specifically stated to the contrary.

In the present disclosure, terms such as first and second are used only for the purpose of distinguishing one component from other components, and do not limit the order or important score of the components unless specifically mentioned. Accordingly, within the scope of the present disclosure, a first component in one embodiment may be referred to as a second component in another embodiment, and similarly, a second component in one embodiment may be referred to as a first component in another embodiment.

In the present disclosure, distinct components are intended to clearly explain each feature, and do not necessarily mean that the components are separated. That is, a plurality of components may be integrated to form one hardware or software unit, or one component may be distributed to form a plurality of hardware or software units. Accordingly, even if not specifically mentioned, such integrated or distributed embodiments are also included in the scope of the present disclosure.

In the present disclosure, components described in various embodiments do not necessarily mean essential components, and some may be optional components. Accordingly, embodiments consisting of a subset of the components described in one embodiment are also included in the scope of the present disclosure. In addition, embodiments that include other components in addition to the components described in the various embodiments are also included in the scope of the present disclosure.

In the present disclosure, “/” and “,” may be interpreted as “and/or”. For example, “A/B” and “A, B” may be interpreted as “A and/or B”. Additionally, “A/B/C” and “A, B, C” may mean “at least one of A, B, and/or C.”

In the present disclosure, “or” may be interpreted as “and/or.” For example, “A or B” may mean 1) “A” only, 2) “B” only, or 3) “A and B.” Alternatively, “or” in the present disclosure may mean “additionally or alternatively.”

### Problems of Related Art

The S-PSR algorithm is a widely used method for reconstructing high-precision meshes based on point cloud data. However, S-PSR has several significant problems and thus has limit point in various applications.

The first problem lies in processing speed and performance. S-PSR is time-consuming when processing large-scale point cloud data, and processing time increases exponentially as high-resolution meshes are generated. In particular, if a separate preprocessing step is not performed when handling large datasets, memory usage can increase dramatically. This performance degradation becomes a significant obstacle when handling complex data in real-time applications or large 3D scenes. In other words, because S-PSR uses point cloud data directly, it is inefficient in terms of processing speed and has difficulty in managing memory usage.

The second problem is the lack of a solution for non-manifold problems. The S-PSR algorithm inherently fails to automatically resolve vertex or face duplication in a mesh generation process, which may lead to non-manifold problems. Non-manifold problems refer to problems where an abnormally large number of faces are connected to a vertex or edge, or where the mesh structure is inconsistent. This problem occurs more frequently when processing point clouds with complex structures, resulting in distorted or unstable meshes. Because these non-manifold problems are difficult to resolve without a separate post-processing step, mesh quality may be degraded and problems may be caused in subsequent work.

The third problem is the lack of texture mapping functionality. The S-PSR algorithm focuses on reconstructing the geometric structure of a mesh, but it has the limitation of not including texture information in the generated mesh. Texture mapping is a crucial element in enhancing the visual completeness of 3D models, especially in applications where visual detail is crucial. However, because S-PSR does not provide the function for assigning texture coordinates or generating texture files, the final generated mesh contains only geometric information, and thus additional texture mapping needs to be performed using external tools.

Furthermore, the difficulty of controlling mesh precision is pointed out as a problem of the S-PSR algorithm. In S-PSR, when generating a mesh from a point cloud, it is difficult to finely control the mesh's precision. This is particularly important for large-scale data. When generating an unnecessarily high-precision mesh, a problem may occur in storage space and processing speed. In contrast, when generating a low-precision mesh, original data cannot be sufficiently represented. S-PSR does not natively include a function for controlling precision by quantizing mesh vertex coordinates, which also requires separate post-processing.

Although the S-PSR algorithm is a suitable method for generating a high-precision mesh, the above-described problems of the S-PSR algorithm make it difficult to satisfy various practical requirements, such as real-time processing, mesh quality, and inclusion of texture information, and this requires additional processing or the introduction of other algorithms to resolve these problems.

### Object and Summary of the Present Disclosure

To address these problems, the present disclosure proposes methods for converting point cloud data used in various application fields, such as 3D scanning, autonomous driving, virtual and augmented reality, and medical imaging, into high-quality meshes. Specifically, the present disclosure proposes methods for generating high-quality meshes by improving the existing S-PSR algorithm and applying down-sampling of point clouds, quantization of mesh vertices, mesh filtering and post-processing, and Laplacian smoothing. In this process, the present disclosure also includes a UV mapping generation procedure through texture mapping, thereby ultimately obtaining a high-quality 3D model. Furthermore, the present disclosure may check various levels of mesh detail by subdividing the mesh depth value from 8 to 12.

The various methods proposed through the present disclosure may be summarized as follows.

First, the present disclosure utilizes the uniform_down_sample function of the Open3D library by introducing a down-sampling (decimation) technique to point cloud data. In other words, the present disclosure can increase processing speed and improve memory efficiency by sampling data at a certain rate before mesh generation.

Next, the present disclosure can save storage space and optimize computation speed by adjusting the precision of the mesh through a quantization technique of mesh vertices, and maximize mesh efficiency by reducing unnecessary precision.

Next, the present disclosure can further improve mesh quality by automating mesh filtering and post-processing operations to address duplicate vertex or non-manifold problems.

Finally, the present disclosure applies texture mapping techniques to add texture information to meshes, thereby creating more realistic and practical 3D models. The present disclosure provides high-quality 3D models by generating OBJ, MTL, and PNG files with final textures through texture mapping, making them readily usable in various 3D modeling and visualization software.

Through these various methods, the present disclosure improves the performance of data processing for point cloud-to-mesh conversion and provides an efficient, high-quality 3D mesh generation process, thereby addressing the challenges associated with large-scale data processing. The present disclosure can be applied to video-based dynamic mesh coding (V-DMC), which is a state-of-the-art dynamic mesh image compression standard.

Hereinafter, embodiments of the present disclosure will be specifically described with reference to the drawings. In describing embodiments of the present disclosure, if a detailed description of a related known configuration or function is judged to obscure the gist of the present disclosure, the detailed description will be omitted. Identical components in the drawings will be designated by the same reference numerals, and redundant descriptions of identical components will be omitted.

Hereinafter, embodiments of the present disclosure will be specifically described with reference to the drawings. In describing embodiments of the present disclosure, if a detailed description of a related known configuration or function is judged to obscure the subject matter of the present disclosure, the detailed description will be omitted. Identical components in the drawings will be designated by the same reference numerals, and redundant descriptions of identical components will be omitted.

### Point Cloud-to-Mesh Conversion and Quality Control System

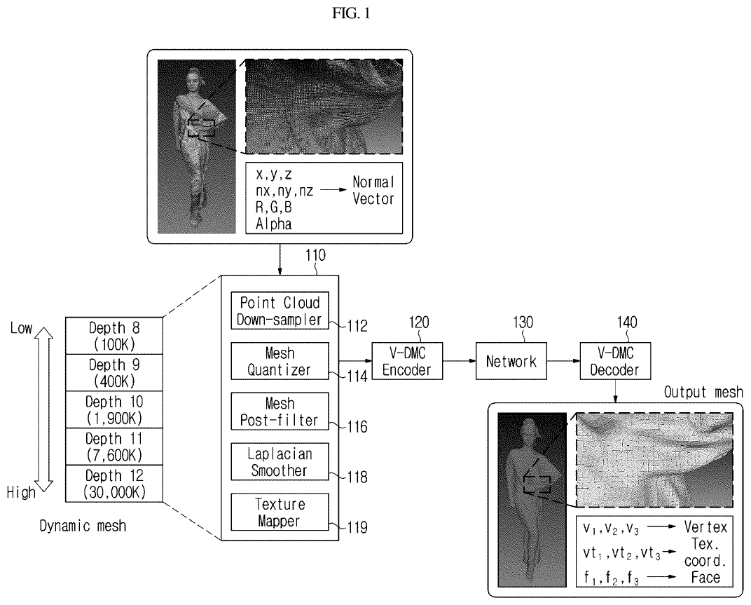

FIG. 1 is a diagram illustrating a point cloud-to-mesh conversion and quality control system according to an embodiment of the present disclosure.

Referring to FIG. 1, the point cloud-to-mesh conversion and quality control system may include a point cloud-to-mesh converter 110, a dynamic mesh compression encoder 120, a network 130, and a dynamic mesh decoder 140. In addition, the cloud-to-mesh converter 110 may include a point cloud down-sampler 112, a mesh vertex quantizer 114, a mesh filtering and post-filter 116, a Laplacian smoother 118, and a texture mapper 119. A point cloud data encoding apparatus may include a point cloud down-sampler 112, a mesh vertex quantizer 114, a mesh filtering and post-filter 116, a Laplacian smoother 118, a texture mapper 119, and a dynamic mesh compression encoder 120. A point cloud data decoding apparatus may include a dynamic mesh decoder 140.

Each point in input point cloud data (original point cloud) consists of three-dimensional coordinates (x, y, z), and based on this, curvature information necessary for mesh generation may be provided. Additionally, each point may represent color information, including RGB values, and may also contain an alpha value indicating transparency. The RGB values may improve the visual representation of point cloud data, and the alpha value may be used to apply additional visual effects, such as translucency.

Normal vectors (ns, ny, nz) may indicate the surface direction of each point, and based on this, the curvature information of the mesh generated from point cloud data may be calculated. Normal vectors may be used to identify the geometric characteristics of a 3D surface and express fine surface details. In particular, normal vectors may serve as a key element in mesh generation in the S-PSR algorithm. The S-PSR algorithm actively utilizes normal vector information as well as positional information of each point to generate a smooth, high-quality mesh while maintaining surface consistency. Therefore, as the normal vectors are accurately calculated, the quality and detail of the generated mesh are improved, and the 3D model with accurate curvature and surface characteristics may be obtained.

During the pre-processing of point cloud data, sampling may be performed to properly handle excessively large point cloud data. The point cloud down-sampler 112 may simplify the point cloud by receiving the point cloud data and using the uniform_down_sample function loaded through the Open3D library. Through this process, the number of points is reduced, thereby reducing computational complexity and optimizing memory usage.

The pre-processed data may then be converted into a format suitable for mesh generation. This process provides optimized data by reducing the resolution of point cloud data, which is an important step in increasing mesh generation efficiency. In the next mesh generation step, the PSR algorithm may be used to generate a mesh from the point cloud. The PSR algorithm is designed to maintain surface consistency and smoothness in the process of forming a 3D mesh based on the coordinate information and normal vectors of the point cloud. Here, an important parameter is a dynamic mesh value with various qualities and, through this, the level of detail in the mesh may be determined. A more detailed mesh is generated when the dynamic mesh value with high quality is set, and a coarse mesh may be generated while computation speed increases when a low dynamic mesh value is set. This algorithm plays a crucial role in generating high-quality meshes, particularly by using normal vector information.

The mesh vertex quantizer 114 may perform quantization on mesh vertices. In the mesh vertex quantization step, the vertex coordinates of the generated mesh are quantized through the quantize_mesh( ) function, thereby saving storage space and reducing unnecessary precision to optimize performance. The quantization process plays an essential role in improving computational performance by adjusting the precision of the mesh, and is a very important optimization task in large-scale data processing. This enables efficient mesh processing and storage.

The mesh filtering and post-filter 116 may improve mesh quality through post-processing after filtering the mesh. In the mesh filtering and post-processing process, the stability of the mesh can be increased and its quality can be improved through post-processing that resolves duplicate vertices and non-manifold problems. In the mesh filtering and post-processing process, the filter_mesh( ) function is executed using the PyMeshLab library, thereby removing duplicate vertices and faces and resolving non-manifold problems, thereby ensuring the structural consistency of the mesh. Therefore, the mesh filtering and post-processing process may be an important process for maintaining the quality of the mesh and enabling stable use in subsequent applications.

The Laplacian smoother 118 may improve the visual quality of a mesh by smoothing its surface. The smooth_mesh( ) function is used during the smoothing process, and the smoothing process may play a crucial role in creating a natural-looking 3D model by smoothing the rough surface of the mesh. This enhances the visual completeness of the mesh and provides high-quality 3D models in various applications.

The texture mapper 119 may perform a texture mapping process on a mesh. The texture mapping process may complete a more visually realistic 3D model by applying a texture to the mesh. The texture mapping process generates a texture file using the get_obj_mtl_png( ) function through PyMeshLab, thereby adding color and detail to the model. The texture mapping process is essential, especially in applications such as modeling, games, and VR/AR, and may be a crucial process for providing a final 3D model with high-quality textures.

The point cloud data encoding apparatus may support various levels of mesh subdivision by setting dynamic mesh values with various qualities from 8 to 12 for the generated mesh. The dynamic mesh values with various qualities may be important parameters that determine the mesh fineness and polygonal subdivision when converting point cloud data into a mesh. When generating the mesh from point clouds using the PSR algorithm, the dynamic mesh with various qualities play a role in adjusting the resolution and level of detail of the generated mesh. Specifically, as the dynamic mesh value with various qualities increases, more detailed information of the mesh is increased and the number of polygons may increase. This may mean that the surface of the 3D model is represented more precisely and a mesh capturing even the finest details is generated. Conversely, if the dynamic mesh value with various qualities is low, the details of the mesh may be reduced and the mesh may be represented in a relatively less detailed format, but computational time and resources may be saved. Therefore, a dynamic mesh value with varying quality can be a crucial factor in balancing mesh quality and computational performance. Accordingly, the dynamic mesh value with various qualities may serve as an important factor in balancing the quality of the mesh and computational performance. For example, when the dynamic mesh value with various qualities is 8, the mesh is composed of a relatively small number of polygons, so the mesh may be generated quickly, but the detail may be reduced. On the other hand, when the dynamic mesh value with various qualities is 12, more polygons are used, which may generate a very detailed mesh, thereby creating a more accurate 3D model, but the calculation time and memory usage may also increase. Therefore, the dynamic mesh value with various qualities should be appropriately adjusted according to the application purpose, and may be set to a large value for tasks requiring high accuracy, and a small value for tasks requiring fast processing and fewer resources. The present disclosure provides a technique that allows users to check various levels of mesh detail by subdividing the dynamic mesh value with various qualities from 8 to 12. However, 8 to 12, which are the dynamic mesh values with various qualities, are presented as simple examples. Depending on the dynamic mesh value with various qualities, the generated mesh may have a different number of faces. For example, when the dynamic mesh value with various qualities is 8, a mesh with approximately 116,052 faces is generated, when the dynamic mesh value with various qualities is 9, a mesh with 469,876 faces is generated, when the dynamic mesh value with various qualities is 10, a mesh with 570,858 faces is generated, when the dynamic mesh value with various qualities is 11, a mesh with 1,090,366 faces is generated, and when the dynamic mesh value with various qualities is 12, a mesh with approximately 1,990,428 faces may be generated. Using the number of faces according to these various depth values is useful for controlling the various qualities of the mesh desired by the user, and may be very useful in 3D modeling and visualization work as it allows the quality to be controlled according to the performance and requirements of the client's equipment.

The dynamic mesh compression encoder 120 may compress original point cloud data and convert the data into an efficient data format for transmission over a network. Since dynamic meshes represent mesh data that changes over time, it is very important to compress the data efficiently when transmitting or storing such data over a network. The dynamic mesh compression encoder 120 performs this role and processes point cloud data and temporal change data of the mesh and converts them into a compressed format to optimize transmission. Because dynamic mesh data is large in size, it is essential to reduce the size of the data through efficient compression. When 3D mesh data is compressed using the dynamic mesh compression encoder 120, even large-scale data may be transmitted quickly and efficiently. This efficiency may be particularly important in real-time streaming or immersive media content. The dynamic mesh compression encoder 120 may apply various pre-processing and conversion processes to improve compression performance. In this process, mesh decimation and subdivision techniques may be used to reduce the number of mesh vertices, thereby significantly reducing the data size of the mesh.

The network 130 may be used as a path for transmitting compressed dynamic mesh data generated from the dynamic mesh compression encoder 120. The compressed data is transmitted to the decoder 140 located at a long distance via the network 130 and may be used in various network environments. The compressed dynamic mesh data may be transmitted via various network types such as the Internet, a local network, and a wireless network, and the network 130 may be efficiently designed to minimize data loss or delay during transmission.

The data transmitted through the network 130 is reconstructed by the decoder, allowing the user to check the original data. The dynamic mesh decoder 140 may reconstruct the compressed data transmitted through the network 130 back to its original 3D mesh form. The dynamic mesh decoder 140 may decode the encoded compressed mesh data and convert it into original mesh data, thereby reconstructing a 3D model that the user can actually use. The dynamic mesh decoder 140 may perform the opposite role of the dynamic mesh encoder 120. The dynamic mesh decoder 140 may focus on reconstructing a high-quality 3D model while minimizing the loss of the transmitted mesh data. In particular, the dynamic mesh decoder 140 may apply various post-processing techniques to accurately reconstruct the compressed mesh data during the reconstruction process, thereby reconstructing a mesh close to the original data. The dynamic mesh decoder 140 may play an important role not only in reconstructing the original data, but also in reducing distortion of the mesh data and improving visual quality.

The output mesh may be the final reconstructed mesh data (reconstructed mesh data). The reconstructed mesh data is a high-quality 3D mesh based on the original point cloud data and may be utilized in various applications. The reconstructed mesh data has textures applied and may be used as a completed 3D model. This reconstructed mesh data may be used in various realistic content such as virtual reality, augmented reality, games, and autonomous driving, and may also be utilized in environments that require real-time processing and transmission. In particular, the mesh to which the encoding method proposed in the present disclosure is applied has minimal loss during data transmission and reconstruction processes and can maintain high visual quality, enabling high-quality 3D modeling and visual representation.

The vertex information of the reconstructed mesh data is represented as v1, v2, and v3, which may represent coordinates that determine the shape of the mesh in three-dimensional space. Each vertex is defined by the (x, y, z) coordinates and the three vertices of a triangle forming a mesh face are connected. Vertices are an important element in determining the structural completeness of a mesh, and accurate vertex locations may significantly impact the shape and quality of the mesh. The texture coordinates of the reconstructed mesh data may be represented as vt1, vt2, and vt3, which may represent texture information corresponding to each vertex. Texture coordinates are defined in two-dimensional space and may be used to map a texture map to the mesh surface in the (u, v) format. Texture coordinates are an important element in determining visual quality, determining how the texture is applied to the mesh surface. The accuracy of texture coordinates is essential to ensure the realistic representation of the model. The face information of the reconstructed mesh data is represented as f1, f2, and f3, which may define a triangular face of the mesh. A face consists of three or four vertices and forms the mesh surface. Each face is an important unit that constitutes the geometric structure of the mesh, and these faces are combined to form the overall shape of the 3D model. Face information is an important element in maintaining the mesh's connectivity and structural completeness.

### Point Cloud-to-Mesh Conversion

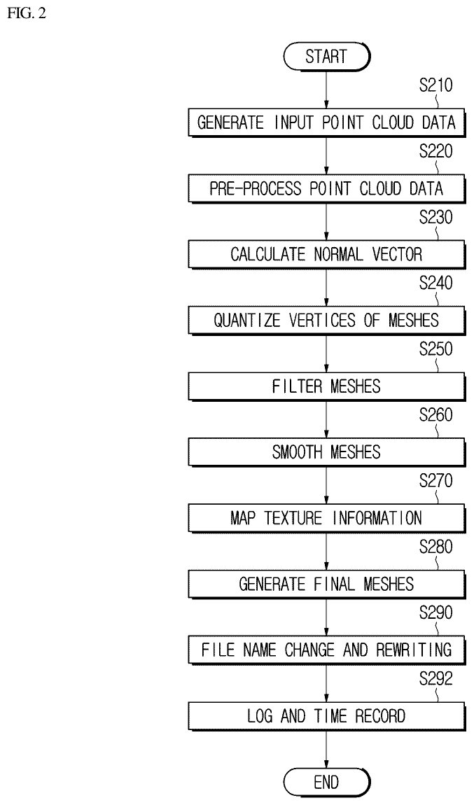

FIG. 2 is a flowchart illustrating a point cloud-to-mesh conversion process for dynamic mesh streaming according to an embodiment of the present disclosure. The steps shown in FIG. 2 may be performed by a point cloud data encoding apparatus.

Referring to FIG. 2, input point cloud data may be generated (S210). A set of thousands or millions of coordinate points (point cloud) representing an object in 3D space may be generated. Each point represents a detailed structure of the object's surface, and the input data (input point cloud data) may be extracted from scanned 3D data or simulation results. The generated input point cloud data may be used as basic data for mesh conversion.

Since it is difficult to process the input point cloud data without change, a pre-processing process may be performed to improve data quality (S220). The pre-processing process may correspond to a process of down-sampling points within the input point cloud data. During the pre-processing process, tasks such as density adjustment, noise removal, and outlier filtering of the input point cloud may be performed. The pre-processing process may correspond to a process for more efficiently generating meshes in subsequent steps and obtaining high-quality meshes. Through the pre-processing process, “point cloud data” may be obtained from the input point cloud data. In other words, the “point cloud data” may be input point cloud data to which the pre-processing process has been applied.

A normal vector may be calculated for each point (S230). The normal vector indicates the slope of a surface where the point is located and may significantly influence a method of forming the vertices of meshes. This process is necessary for mesh generation, and the result (normal vector) may be used to control the smoothness and detail of the surface during subsequent mesh generation process.

Quantization may be performed on the vertices of meshes within a point cloud (S240). That is, a vertex quantization process may be applied to a point cloud for which normal vectors have been calculated before being converted into a mesh. During the vertex quantization process, the position values of the mesh vertices may be precisely adjusted so that they have a consistent spacing. Through this, the structure of the mesh may be made uniform and the data size may be reduced. The quantized vertices play an important role in the mesh generation process and may provide the basis for generating an accurate and consistent mesh.

Based on the quantized vertices, final meshes (final mesh data) may be generated. The process of generating the final mesh data will be described in detail below.

Filtering of meshes may be performed (S250). This process may include mesh filtering and deduplication. The meshes generated from the point cloud often contain unnecessary vertices or have problems with adjacent vertices being duplicated. These duplicate vertices may degrade the quality of the mesh, and thus may be removed through the filtering and deduplication processes. In addition, the accuracy of the mesh can be improved by removing unnecessary noise or outliers through the filtering and deduplication processes.

Meshes whose vertices have been trimmed (or filtered) may be smoothed (S260). During the smoothing process, rough parts or unnecessary protrusions in the mesh are smoothed out, forming a natural surface. The smoothing process is a process of generating a visually smoother and softer mesh, and the final mesh quality may be significantly affected by this smoothing process. The meshes may be smoothed by moving each vertex based on a weighted average of its neighboring vertices.

Texture information and/or UV information may be generated and mapped to the smoothed meshes (S270). Texture information generation is a process of adding detailed visual information to the mesh surface, and UV information mapping may be a process of aligning the coordinates of the 3D mesh to a 2D texture space. The texture information may include color information of each of the smoothed meshes. Through this process, the mesh may have realistic colors and details, thereby completing a more realistic 3D model. The color information, i.e., the texture information, may be an RGB value or an alpha value indicating transparency.

Final meshes may be generated based on the meshes to which the mapping process is applied (S280). For example, the final meshes for each of predetermined quality values (dynamic mesh values having various qualities) may be generated from the mapped meshes. The predetermined quality values may be determined based on different depth values or resolution values. The predetermined quality values may include one value (a first value) and another value (a second value), and the second value may be smaller than the first value. In this case, for the final meshes for the first value, at least one of the number of meshes or the number of vertices may be greater, compared to the final meshes for the second value.

The final meshes are in a state of completing the above-described steps, and may be converted into 3D files in various formats. The process of generating the final meshes includes mesh storage, file format conversion, file name change, and rewriting (S290). Through S290, the data may be managed in the manner desired by a system user.

Logs and processing times generated during mesh processing may be recorded and managed (S292). These records may be used for future analysis and debugging, evaluating the efficiency of the processing, and, if necessary, identifying areas for future improvement. Log and time record may be important crucial management elements of the entire process.

### 3D Mesh Generation

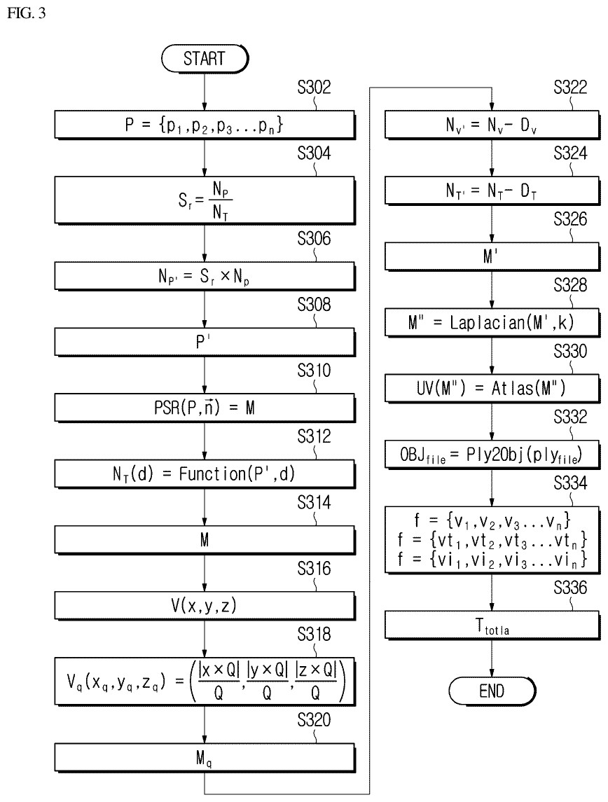

FIG. 3 is a diagram showing an example of a method of generating a high-quality 3D mesh through point cloud data processing and an improved S-PSR algorithm.

In FIG. 3, P represents an input point cloud, Np represents the number of input point clouds, and N_{T} represents the number of target points. In addition, Sᵣ represents a sampling ratio for the number of target points, P′ represents a down-sampled point cloud, and N_{P′} represents the number of down-sampled point clouds. In addition, \vec{n} represents a normal vector, d represents a mesh depth, and M represents an output triangle mesh file. In addition, N_{T}(d) represents the number of output triangle mesh faces, V represents the vertices of the generated mesh file M, and Q represents a quantization level (precision adjustment). In addition, Mq represents the quantized mesh, N_{T} represents the number of faces of an original mesh, and D_{T} represents the number of faces of the duplicated mesh. In addition, N_{T} represents the number of faces of the mesh from which duplicates have been removed, M′ represents a filtered mesh file, and k represents the number of iterations of Laplacian smoothing. In addition, M″ represents a mesh to which Laplacian smoothing is applied, Atlas(M″) represents texture generation and UV mapping, and OBJ_{file}=Ply2Obj(ply_{file}) represents converting the point cloud file to a mesh file. In addition, f={v₁, v₂, v₃, . . . , vₙ} represents the vertices of the mesh, f={vₜ₁, vₜ₂, vₜ₃, . . . , vₜₙ} represents the coordinates of the mesh, and f={vi₁, vi₂, vi₃, . . . , viₙ} represents the indices of the mesh (the faces of the mesh). In addition, Tₜₒₜₐₗ represents a sum of the time of each step.

Referring to FIG. 3, the process of processing point cloud data aims to gradually convert data through several steps and ultimately generate a high-quality 3D mesh. This process is an important procedure for efficiently processing point cloud data and mapping texture to enhance the visual completeness of the 3D model.

S302 is a point cloud preprocessing step. The input point cloud P consists of Np points containing 3D coordinate information. Generally, point cloud data has a very large size, and processing such large data is inefficient in terms of memory and computation time. Therefore, the data size may be reduced through down-sampling. For down-sampling, the number N_{T} of target points is first set, and the sampling ratio Sr is calculated based on this (S304). The sampling ratio may be defined as the ratio of the number N_{T} of target points to the number N_{P} of original points.

Using this sampling ratio, some points are selected from the original point cloud P, thereby generating a down-sampled point cloud P′ (S308). The number N_{p′} of down-sampled points may be calculated based on the sampling ratio Sr and the number Np of original points (S306). Through the down-sampling process, the size of the data can be reduced, thereby improving computational performance and reducing memory usage. The down-sampled point cloud P′ may serve as basic data for more efficient processing in subsequent steps.

A triangle mesh M may be generated using the down-sampled point cloud P′ (S310). At this time, a PSR algorithm may be used (S310). The PSR algorithm may receive a normal vector \vec{n} for each point of the point cloud as input, estimate a 3D representation based on this, and then generate the triangle mesh M. The result of applying the PSR algorithm is a triangle mesh M (S314), and the details of the mesh may vary depending on the depth d of the mesh (S312). The deeper the depth of the mesh, the more details there are, and the more triangle faces may be generated. The number N_{T}(d) of faces of the generated mesh may be expressed as a function according to the depth d (S312).

Therefore, the user may determine the desired level of detail of the mesh, and generate a more precise mesh by adjusting the depth d. However, since a larger depth requires more computational resources, it is necessary to find an appropriate balance between computational performance and quality. After the mesh is generated, mesh vertex quantization may be performed. Quantization may be a process of compressing the coordinates of each vertex of the mesh to reduce storage space and optimize data size. The quantization level Q is an important factor in controlling precision, and may be processed by dividing the vertex coordinates into a specific interval and then performing a rounding operation. The vertex coordinates V(x, y, z) (S316) may be quantized using the equation shown in S318.

The quantized vertices Vq contribute to reducing the storage size of the mesh, through which the quantized mesh Mq may be obtained (S320). The step S320 may be a process for maximizing the space efficiency of the mesh. A mesh filtering process may be performed based on the quantized mesh Mq. In the mesh filtering process, duplicate vertices and faces are removed, and the non-manifold structure of the mesh is modified, so that the quality of the mesh can be improved. After the number D_{V} of duplicate vertices is removed (S322), the number of filtered vertices may be calculated as in S322. Similarly, the number of faces after the number D_{T} of duplicate faces is removed may be calculated as in S324.

The filtered mesh file M′ (S326) may be stored in an optimized state with duplicate information removed. Through this process, it is possible to reduce the size of the mesh and improve data quality. Once mesh filtering is complete, a mesh smoothing process may be performed. In the mesh smoothing process, the Laplacian smoothing algorithm may be used to smoothly process the mesh representation. The Laplacian smoothing algorithm calculates the average position of adjacent vertices of each vertex to smooth the surface. The mesh smoothing process is repeated k times, and a smoother surface may be obtained as the number of iterations increases. The smoothed mesh M″ may be expressed by the equation of S328. Through the mesh smoothing process, rough parts of the mesh are alleviated, and a visually smoother and more natural 3D model may be completed.

Based on the smoothed mesh M″, texture generation and UV mapping processes may be performed. Texture mapping may be a process of adding a texture image to the surface of a 3D model by assigning texture coordinates UV(u, v) to each vertex of the mesh. Through this, the visual completeness of the model can be improved. UV mapping may be expressed by the equation of S330. Texture coordinates are generated during the texture generation and UV mapping processes, and finally, a mesh Mₜₑₓₜᵤᵣₑ to which texture is applied may be generated. Through the mesh to which texture is added, a realistic and complete 3D model, rather than a simple geometric model, may be created.

A process of converting the generated mesh file into the OBJ file format may be performed. This process converts the mesh file generated based on point cloud data into the OBJ format and may be expressed as the equation of S332. An MTL file may also be generated along with the file, and a reference paths for the texture file may be properly modified to ensure accurate texture application. Through this, the 3D model file is finally completed and path problems can be solved.

The final mesh file may be composed of several elements that define the geometric structure and visual details of the mesh. These elements may be divided into vertex information, texture coordinate information, and face information. Vertex information may define the geometric structure of the mesh. Each vertex is modified to 3D coordinates, and through this, the basic shape of the mesh may be determined. Vertices may be expressed as f={v₁, v₂, v₃, . . . , vₙ} of S334, where vₙ is a coordinate in 3D space, representing a vertex of the mesh surface. These vertices play a role in defining the shape of the object and may define the overall shape of the mesh. Texture coordinate information may be used to add a visual representation to the mesh. The texture coordinate corresponding to each vertex is expressed as a two-dimensional coordinate and determines a method of applying the texture map to the mesh surface. The texture coordinate may be expressed as f={vₜ₁, vₜ₂, vₜ₃, . . . , vₜₙ} of S334. Here, vtₙ is a two-dimensional coordinate on the texture map and represents the texture coordinate corresponding to each vertex. Texture coordinate information is used to add color and fine details to the surface of the mesh, which can improve the visual quality of the mesh. Face information is an element that determines the structure of the mesh, and includes information on triangles or polygons that connect each vertex to form a face. Face information may be expressed as f={vi₁, vi₂, vi₃, . . . , viₙ} of S334. Here, viₙ represents the vertex index that constitutes each face, and the structural connectivity of the mesh surface may be described through this. Face information may play a role in configuring the surface of the mesh and defining the overall 3D structure.

When the final mesh is generated, the processing time for each step is recorded throughout the entire process, and the total processing time Tₜₒₜₐₗ may be calculated by adding the times taken for each step. The total processing time may be calculated as shown in Equation 1.

$${T}_{total} = {T}_{process} + {T}_{mesh} + {T}_{quantize} + {T}_{smooth} + {T}_{texture} + {T}_{rewrite} \qquad [ Equation 1 ]$$

Based on the total processing time, the efficiency of each step may be evaluated, and the time of all steps may be managed.

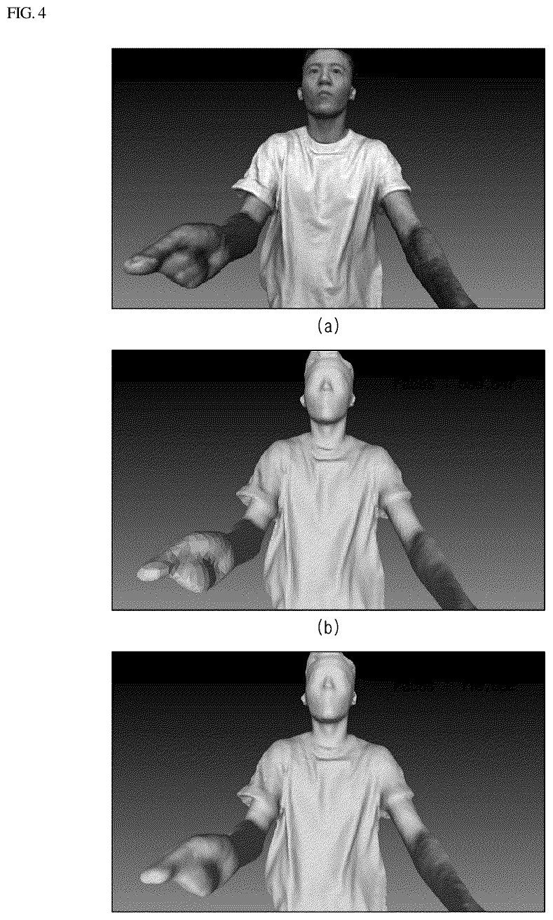

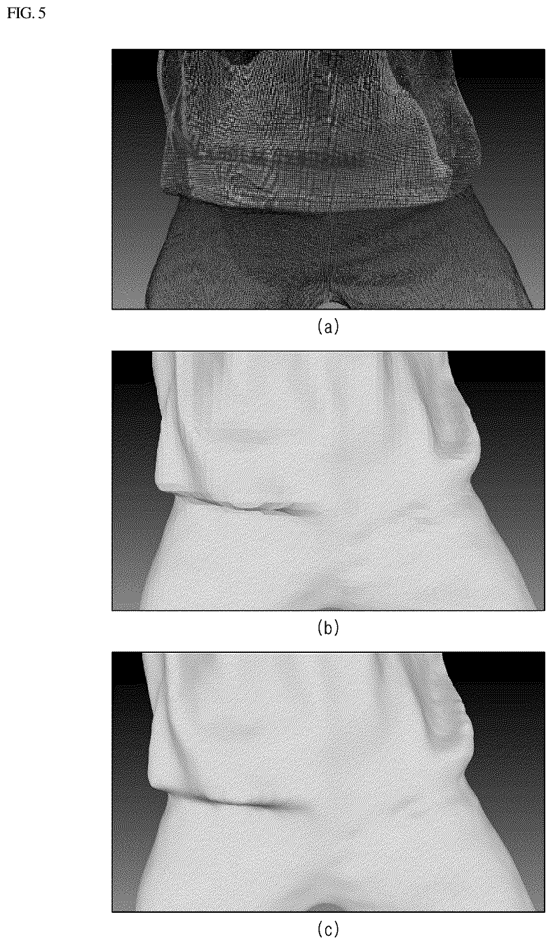

FIGS. 4 and 5 show examples of comparing original point cloud data, the results of applying the conventional S-PSR algorithm, and the results of applying the method proposed through the present disclosure.

The original point cloud data has 2,559,748 point clouds, the depth value applied to conversion is 8, and the number of iterations of Laplacian smoothing is 5.

(a) of FIGS. 4 and 5 show original cloud data. (b) of FIGS. 4 and 5 show a 3D model generated by applying the conventional S-PSR algorithm, in which the number of point clouds is the same as the original cloud data, and the number of faces is 589,647. (c) of FIGS. 4 and 5 show a 3D model generated by applying the method proposed through the present disclosure, in which the number of point clouds is reduced to 59,964, and the number of faces is also reduced to 116,052.

As shown in FIGS. 4 and 5, it can be seen that the method proposed through the present disclosure generates a smoother 3D model while reducing the number of point clouds and the number of surfaces compared to the conventional S-PSR algorithm.

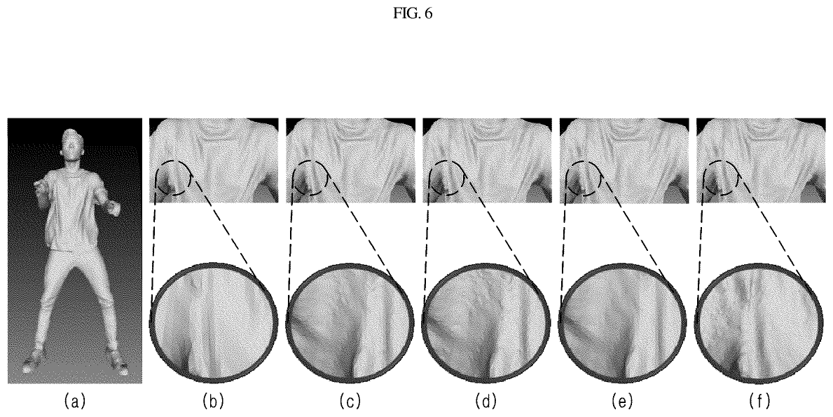

FIG. 6 shows an example of generating a dynamic mesh with various qualities by varying the depth value from 8 to 12. As shown in FIG. 6, it can be seen that if the depth value is relatively small, the mesh may be composed of a relatively small number of polygons, which may reduce the detail, but if the depth value is relatively large, the polygons are used, which may generate a very detailed mesh, which may result in the generation of a more accurate 3D model. Therefore, according to the method proposed through the present disclosure, the user may check various levels of mesh detail, control various qualities of the desired mesh, or control the quality according to the performance and requirements of the client equipment, which may be very useful in 3D modeling and visualization work.

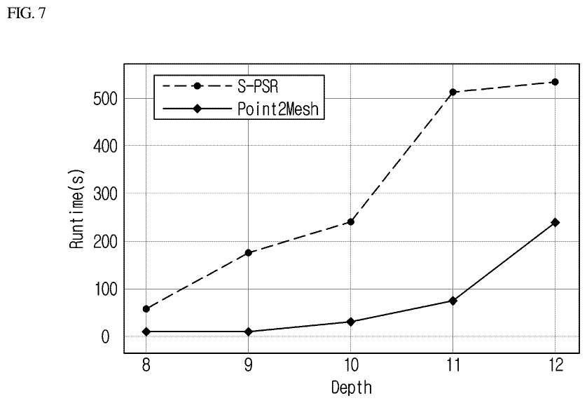

FIG. 7 is a graph comparing the processing time (runtime) according to depth value between the conventional S-PSR algorithm (S-PSR) and the method (Point2Mesh) proposed through the present disclosure. As shown in FIG. 7, it can be seen that, for all depth values from 8 to 12, the processing time of the method proposed through the present disclosure is superior to that of the conventional S-PSR algorithm.

In the embodiments described above, the methods are described based on a flowchart as a series of steps or units; however, the present disclosure is not limited to the order of the steps, and some steps may occur in a different order or simultaneously with other steps described above.

Additionally, those skilled in the art will appreciate that the steps depicted in the flowchart are not exclusive, and that other steps may be included or one or more steps of the flowchart may be deleted without affecting the scope of the present disclosure.

The above-described embodiments include examples of various aspects. While it is not possible to describe all possible combinations to illustrate the various aspects, those skilled in the art will recognize that other combinations are possible. Accordingly, the present disclosure is intended to encompass all other alterations, modifications, and variations within the scope of the following claims.

The embodiments of the present disclosure described above may be implemented in the form of program instructions that can be executed by various computer components and recorded on a computer-readable recording medium. The computer-readable recording medium may include program instructions, data files, data structures, etc., alone or in combination. The program instructions recorded on the computer-readable recording medium may be those specially designed and configured for the present disclosure or may be known and available to those skilled in the art of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute program instructions such as ROMs, RAMS, and flash memories. Examples of program instructions include not only machine language codes generated by a compiler, but also high-level language codes that may be executed by a computer using an interpreter, etc. The hardware devices may be configured to operate as one or more software modules to perform processing according to the present disclosure, and vice versa.

In the embodiments described above, the methods are described based on a flowchart as a series of steps or units. However, the present disclosure is not limited to the order of the steps, and some steps may occur in a different order or simultaneously with other steps described above. Furthermore, those skilled in the art will appreciate that the steps depicted in the flowchart are not exclusive, and that other steps may be included, or one or more steps of the flowchart may be deleted without affecting the scope of the present disclosure.

The above-described embodiments include examples of various aspects. While it is not possible to describe all possible combinations to illustrate the various aspects, those skilled in the art will recognize that other combinations are possible. Accordingly, the present disclosure is intended to encompass all other alterations, modifications, and variations within the scope of the following claims.

The embodiments of the present disclosure described above may be implemented in the form of program instructions that can be executed by various computer components and recorded on a computer-readable recording medium. The computer-readable recording medium may include program instructions, data files, data structures, etc., alone or in combination. The program instructions recorded on the computer-readable recording medium may be those specially designed and configured for the present disclosure or may be known and available to those skilled in the art of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute program instructions such as ROMs, RAMs, and flash memories. Examples of program instructions include not only machine language codes generated by a compiler, but also high-level language codes that may be executed by a computer using an interpreter, etc. The hardware devices may be configured to operate as one or more software modules to perform processing according to the present disclosure, and vice versa.

Although the present disclosure has been described above with specific details such as specific components and limited examples and drawings, these are provided only to help a more general understanding of the present disclosure, and the present disclosure is not limited to the above examples, and a person having ordinary knowledge in the technical field to which the present disclosure belongs may make various modifications and variations from this description.

Therefore, the spirit of the present disclosure should not be limited to the embodiments described above, and all modifications that are equal or equivalent to the following claims as well as the claims are considered to fall within the scope of the spirit of the present disclosure.

According to the present disclosure, point cloud data can be efficiently processed to generate a high-resolution 3D mesh, thereby providing a realistic visual experience in various application fields. Therefore, it is possible to provide a more immersive environment to users.

Furthermore, according to the present disclosure, data processing speed can be improved and memory usage can be reduced through techniques such as down-sampling of point cloud data, mesh vertex quantization, and filtering.

Furthermore, according to the present disclosure, through efficient compression of meshes, storage space can be saved and bandwidth can be reduced during data transmission, which can be advantageous for real-time data processing.

The effects that can be obtained from the present disclosure are not limited to the effects mentioned above, and other effects that are not mentioned will be clearly understood by a person having ordinary skill in the art to which the present disclosure pertains from the description below.

What is claimed is:

1. A method of encoding point cloud data, the method comprising:
obtaining the point cloud data;
quantizing vertices of meshes within the obtained point cloud data; and
generating final meshes based on the quantized vertices.

2. The method of claim 1, further comprising down-sampling points within input point cloud data,
wherein the obtained point cloud data is point cloud data to which the down-sampling is applied.

3. The method of claim 1, wherein the generating the final meshes comprises filtering at least one of duplicate vertices or non-manifolds of meshes having the quantized vertices.

4. The method of claim 3, wherein the generating the final meshes further comprises smoothing the filtered meshes.

5. The method of claim 4, wherein the filtered meshes are smoothed by moving each vertex of the filtered meshes based on a weighted average of neighboring vertices.

6. The method of claim 4,
wherein the generating the final meshes further comprises mapping texture information to the smoothed meshes, and
wherein the texture information includes color information of each of the smoothed meshes.

7. The method of claim 6,
wherein the generating the final meshes further comprises generating final meshes for each of predetermined quality values from the mapped meshes, and
wherein the predetermined quality values are determined based on different depth values or different resolution values.

8. The method of claim 7,
wherein the predetermined quality values include a first value and a second value smaller than the first value, and
wherein for final meshes for the first value, at least one of the number of meshes or the number of vertices is greater, compared to final meshes for the second value.

9. An apparatus for encoding point cloud data, the apparatus comprising:
a memory; and
at least one processor,
wherein the at least one processor is configured to:
obtain the point cloud data;
quantize vertices of meshes within the obtained point cloud data; and
generate final meshes based on the quantized vertices.

10. A method for transmitting data generated by a method of encoding point cloud data, the method of encoding the point cloud data comprising:
obtaining the point cloud data;
quantizing vertices of meshes within the obtained point cloud data; and
generating final meshes based on the quantized vertices.
